(19) United States
(12) Patent Application Publication
(10) Pub. No.: US 2011/0233003 A1
(43) Pub. Date: Sep. 29, 2011

(54) Transmission

(75) Inventor: Sonke Siegfriedsen, Rendsburg (DE)

(73) Assignee: AERODYN ENGINEERING GMBH, Rendsburg (DE)

(21) Appl. No.: 13/126,316

(22) PCT Filed: Oct. 30, 2009
(86) PCT No.: PCT/DE2009/001516

§ 371 Date: Apr. 27, 2011

(30) Foreign Application Priority Data
Nov. 3, 2008 (DE) 10 2008 055 632.7

(51) Int. Cl. F16N 39/02

(52) U.S. Cl. 184/26

(57) ABSTRACT

A transmission, having a connection for the supply of transmission oil and a connection for the discharge of transmission oil, characterized by a compressor which generates an overpressure in the transmission interior space, wherein the magnitude of the overpressure is controlled as a function of the air temperature outside the transmission and/or as a function of the temperature in the transmission interior and/or as a function of the temperature difference between the temperature of the lubricating oil supplied to the transmission and the temperature of the lubricating oil discharged from the transmission.

The invention relates to a transmission, having a connection for the supply of transmission oil and a connection for the discharge of transmission oil.

The components of the transmission that move relative to each other are lubricated to reduce friction and material wear. In the case of transmissions this usually takes place in that the transmission exhibits an (open) lubricating-oil circuit in which the transmission is connected to a line supplying lubricating oil and a line discharging lubricating oil from the transmission, the line supplying lubricating oil and the line discharging lubricating oil being connected by means of a pump.

However, in the case of closed-circuit oil lubrication there is the problem that the lubricating oil must be kept viscous over a large temperature range without the lubricating behaviour of the oil being adversely affected, thus leading to a situation that reduces the transmission function and/or the service life of the transmission.

For example in the case of wind turbines at locations with very low annual temperature averages, e. g. in Inner Mongolia, in Siberia, and also in Canada, there is the problem that starting up the wind turbine after climate induced shutdown and the plant having cooled down can lead to damage to the transmission. At temperatures below −20° C. the lubricating oil that was warmed up in the oil tank after starting the plants and in the feed connection of the transmission is fed to the lubricating points of the transmission, cools down there and flows into the oil sump only very slowly or not at all.

For transmissions that are deployed in very cold regions certain chemical compounds and material mixtures are already used that exhibit only little change in viscosity over a large temperature range and withstand the high loads in the transmission without any change. In addition the attempt is also being made to aid in maintaining the viscosity of these lubricating oils by providing heating elements, for example heatable jackets of lines that feed lubricating oil to the transmission or heating rods integrated into the lumen of the lines, that keep the lubricating oil at a temperature that maintains the desired lubricating attributes and the viscosity of the lubricating oil at least in the feeding lines.

Despite this there is still the problem that has been mentioned that the lubricating oil will cool down strongly when the oil is supplied to the components of the transmission that need lubricating, i.e. on introduction into the transmission interior space if the transmission is subject to very low outside temperatures. Therefore due to insufficient lubrication and at the same time insufficient heat dissipation—that usually takes place using the lubricating oil -, transmissions at locations with very low outside temperatures are prone to transmission faults.

The object of the invention is therefore to create a transmission that guarantees sufficient circulation of the oil even at low temperatures without much outlay and thus also guarantees adequate lubrication and cooling of the transmission components.

The object is achieved by the transmission having the features of claim 1. The sub claims specify advantageous embodiments of the invention.

The basic idea of the invention is to counteract the problems mentioned above in that, as a function of predetermined parameters, an air pressure is applied to the transmission interior space that is higher relative to atmospheric pressure and that flow of the lubricating oil through the transmission can take place approximately independently of the temperature difference between oil carrying connection and transmission in that the overpressure created above the oil sump forces the oil out of the transmission interior space via the oil-discharging connection. According to the invention the transmission exhibits a compressor to this end.

Preferably also a control system is provided that limits the overpressure created by the compressor to a value that is smaller relative to the injection pressure of the lubricating oil so that it is ensured that oil can be fed to the transmission at any time. Particularly preferably it is also provided that both the overpressure created by the compressor and the injection pressure can be regulated by the control system while the feature mentioned can be complied with.

The level of the overpressure is preferably governed by the air temperature outside the transmission, the temperature in the transmission interior space, the oil level in the transmission interior space, the temperature difference between the temperature of the lubricating oil supplied to the transmission and the temperature of the lubricating oil discharged from the transmission, the flow velocity in the oil drain, the viscosity and/or the difference of the volume flow of lubricating oil fed to and discharged from the transmission. Suitable sensors are to be provided as a function of the selected parameter that are connected in a communicating manner to the control system driving the compressor and/or an evaluation unit connected to the control system.

It is finally also preferred that the compressor exhibits a filter device for separating off aerosols and/or moisture to preclude damage to the compressor and the transmission by particles or by moisture.

To the person skilled in the art it is obvious that the seals sealing the transmission have to be sized such that they can withstand any overpressure applied in the transmission interior space. When an overpressure of 500 hPa is applied to the transmission interior space, brush seals have to be used that withstand these loads. Labyrinth seals can be used here only as axial shaft seals.

The structure of an inventive lubricating-oil circuit is now such that a transmission, a line feeding lubricating oil to the transmission, a line discharging lubricating oil from the transmission and a pump connected to the line feeding lubricating oil and the line discharging lubricating oil are provided, a compressor connected to the transmission introducing outside air, or air from the nacelle interior space in the case of a transmission of a wind turbine, into the transmission interior space, creating a predetermined air pressure in the process that serves to maintain the oil flow in the circuit.

Preferably a tank is provided from which a pump feeds lubricating oil to the transmission via the line that feeds lubricating oil to the transmission, the lubricating oil being discharged via the line discharging lubricating oil from the transmission being fed back again to the tank. In the tank the lubricating oil is brought to a prespecified temperature and kept for feeding to the components of the transmission that are in need of lubrication. It is equally advantageous to provide the lines that feed lubricating oil with heating elements, e. g. heating rods integrated into the lumen of the lines or jackets that can be brought to a certain temperature, so as to maintain the temperature range in the lubricating-oil circuit suitable for the viscosity of the oil.

The compressor should further exhibit a filter device for separating off aerosols and/or moisture from the air to be fed to the transmission interior space so that no particles that can damage the transmission can reach the transmission interior space.

Preferably also a control system is provided that limits the overpressure generated by the compressor to a value that is smaller relative to the injection pressure of the transmission. This is to prevent that at the same time transmission oil is forced out of the transmission via the drain and feeding transmission oil via the inlet is prevented on account of unfavourable pressure conditions.

Since the environmental and temperature conditions change periodically, e. g. during the course of a day, a control system is preferably also provided that regulates the level of the air pressure or overpressure (in relation to atmospheric pressure) created in the transmission interior space as a function predetermined parameters. These predetermined parameters can for example be the air temperature outside the transmission or, in case the transmission is integrated into a wind turbine, outside the wind turbine, the temperature in the transmission interior space, the oil level in the transmission interior space, the temperature difference between the temperature of lubricating oil fed to the transmission and lubricating oil discharged from the transmission, and/or the difference in volume flow between lubricating oil fed to the transmission and lubricating oil discharged from the transmission.

If the lubricating-oil circuit is designed as an open-loop circuit the air pressure in the transmission interior space can be controlled in a particular simple manner by simply having the compressor switched on by the control system since the air pressure in the transmission will automatically adapt to atmospheric air pressure. For example a pressure-measuring device can be provided that switches the compressor on and off.

In this way the air pressure can for example be increased when a predetermined measured oil-level is exceeded, or be equalized again to atmospheric pressure by switching off the compressor when the measured oil level is too low.

Equally, when operating the plant into which the transmission is integrated, for example a wind turbine, the air pressure in the transmission interior space can be increased as soon as the transmission interior temperature is undercut and/or transmission oil is being conveyed but does not flow off.

Finally also a method for lubricating a transmission using oil is claimed.

As is know from the prior art, lubricating oil is fed to those components of the transmission and discharged again that are in need of lubrication. In the process a pressure that is higher than the atmospheric air pressure surrounding the transmission is created according to the invention for effecting a certain oil outflow from the transmission.

Care must be taken here as well that the overpressure created in the transmission interior space is smaller than the injection pressure of the transmission oil.

The predetermined higher pressure results, as already mentioned above, from the air temperature outside the transmission / the wind turbine, the temperature in the transmission interior space, the oil level in the transmission interior space, the temperature difference between the temperature of lubricating oil fed to the transmission and lubricating oil discharged from the transmission and/or the difference in volume flow between lubricating oil fed to the transmission and lubricating oil discharged from the transmission.

Of course care must be taken here as well that the seals withstand the air pressure created in the transmission interior space preferably using purified and/or dried air.

1. A transmission, having a connection for the supply of transmission oil and a connection for the discharge of transmission oil, comprising:
a compressor which generates an overpressure in an interior space of the transmission, wherein a magnitude of the overpressure is controlled as a function of air temperature outside the transmission or as a function of a temperature in the interior space or as a function of a temperature difference between the a temperature of lubricating oil supplied to the transmission and a temperature of lubricating oil discharged from the transmission.

2. The transmission according to claim 1, further comprising a control system that limits the overpressure created by the compressor to a value that is smaller relative to an injection pressure of the lubricating oil.

3. The transmission according to claim 2, wherein a level of the overpressure is in addition controlled as a function of an oil level in the interior space, a flow velocity in an oil drain, a viscosity or a difference of a volume flow of lubricating oil fed to and discharged from the transmission.

4. The transmission according to claim 1, wherein the compressor has a filter device for separating off aerosols or moisture.

5. A lubricating-oil circuit comprising:
a compressor which generates an overpressure in an interior space of the transmission, wherein a magnitude of the ovwressure is controlled as a function of air temperature outside the transmission or as a function of a temperature in the interior space or as a function of a temperature difference between a temperature of lubricating oil supplied to the transmission and a temperature of lubricating oil discharged from the transmission,
a line feeding lubricating oil to the transmission,
a line discharging lubricating oil from the transmission; and
a pump connected to the line feeding lubricating oil and the line discharging lubricating oil.

6. The lubricating-oil circuit according to claim 5, further comprising a tank arranged in the lubricating-oil circuit for providing or keeping lubricating oil at a specified temperature.

7. The lubricating-oil circuit according to claim 5, wherein the line feeding lubricating oil exhibits heating elements for keeping the lubricating on at a specified temperature.

8. The lubricating-oil circuit, according to claim 5, wherein the transmission is the transmission of a wind turbine.

9. The lubricating-oil circuit according to claim 5, wherein the level of the overpressure is controlled asas a function of the air temperature outside the wind turbine.

10. method for lubricating a transmission using oil, comprising the steps of;
feeding oil to those components of the transmission that are in need of lubrication,
discharging the oil from the transmission, and
creating a controlled pressure in an interior space of the transmission that is higher relative to atmospheric air pressure surrounding the transmission, as a function of the air temperature outside the transmission or a temperature in the interior space or a temperature difference between the lubricating oil supplied to the transmission and lubricating oil discharged from the transmission, to effect a predetermined oil outflow from the transmission.

11. The method according to claim 10, further comprising: creating an overpressure in the transmission interior space which is smaller than an injection pressure of the transmission oil.

12. The method according to claim 11, wherein a level of the overpressure is additionally controlled as a function of an oil level in the interior space, a flow velocity in an oil drain, a viscosity or a difference of a volume flow of lubricating oil fed to and discharged from the transmission.

13. The method according to claim 10, further comprising: creating an air pressure in the interior space using air purified from aerosols or dried air.

14. The method according to claim 10, further comprising: keeping the oil fed to the transmission at a specific temperature.
